(19) United States
(12) Patent Application Publication
(10) Pub. No.: US 2011/0048555 A1
(43) Pub. Date: Mar. 3, 2011

(54) SINK ALERT WATER LEAK DETECTOR

(76) Inventors: SAM MALOUF, CHINO, CA (US); RAMSIS BOULES, CHINO, CA (US); ANTWAN DEPAUL, CHINO, CA (US)

(21) Appl. No.: 12/873,858

(22) Filed: Sep. 1, 2010

Related U.S. Application Data
(60) Provisional application No. 61/239,435, filed on Sep. 3, 2009.

(51) Int. Cl. F16K 37/00

(52) U.S. Cl. 137/551

(57) ABSTRACT

Improvements in a sink alert water leak detector is disclosed using a collection tub is configurable in a variety of sizes or shapes to cover the area under the plumbing of a sink or other area that can have a potential water leak. The bottom of the collection tub to be angled so even minor amounts of water to run down to a specific area of the collection tub to a sensor circuit using a plurality of contacts that are placed in the lowest location of the collecting tub where water will run down to and thereby bridge the plurality of contacts and trigger an alarm. The collection tub can have elevated feet to allow for air movement under the collecting tub. The collection tub may also have internal support members that provide an elevated surface for the storage of personal items within the cabinet.

### CROSS REFERENCE TO RELATED APPLICATION

This application claims the benefit of Provisional 61/239,435 filed Sep. 3, 2010 the entire contents of which is hereby expressly incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention This invention relates to improvements in a water leak detection device. More particularly, the present sink alert water leak detector provides a water collection pan with an audible alarm to notify a person that a leak is occurring under a water distribution apparatus.

2. Description of Related Art Including Information Disclosed Under 37 CFR 1.97 and 1.98

Several products and patents have been made sold or patented that provide some of the pieces that are disclosed in this application. For one or more reasons these devices don't provide the complete solution to the problem of water leak detection that is found in this application. Exemplary examples of patents covering these products are disclosed herein.

U.S. Pat. No. 5,091,715 issued Feb. 25, 1992 to Anthony J. Murphy discloses a Leak Detection and Alarm System. The patent has an enclosure with a plurality of feet, and each foot has an inner and an outer conductor. When water makes contact between the two conductors of the feet an electronic circuit will sound an alarm. While this invention has an alarm that sounds when one or more of the feet come in contact with water the invention must be placed in the specific location where water will be located. Because of the small size of the alarm it can be easily moved from its original location under a sink.

U.S. Pat. No. 6,639,517 issued Oct. 28, 2003 to James Chapman et al., discloses a Leak Detection Mat and System. The patent discloses using a pad with interwoven contacts. When sufficient water is absorbed into the pad the water will make contact with conductive sensors that will trigger an alarm. The pad provides a limited amount of collection of fluid. If a major water break occurs the absorbed volume of the pad can be insufficient to contain all of the water. The pad can also transfer some water to the underlying cabinet floor and thereby cause damage to the cabinet.

U.S. Pat. No. 6,873,263 issued Mar. 29, 2005 to Leonard Hohman discloses a Water Leak Detector. The patent has an enclosure with an inner and an outer conductor. When water makes contact between the two conductors an electronic circuit will sound an alarm. While this invention has an alarm that sounds when water bridges the contacts, the invention must be placed in the specific location where water will be located. Because of the small size of the alarm it can be easily moved from its original location under a sink.

U.S. Pat. No. 7,084,777 issued Aug. 1, 2006 to Jeffrey A. Ninberg discloses a Fluid Leak Detection Device. This patent uses one or more valleys with raised sides or hills with conductors placed in the valleys. Water that drops onto the device will run into the valleys and make contact with the conductors to sound an alarm. The patent does not have any method of collecting the water from the valleys, and excessive water will run off of the device and cause harm to the cabinet.

What is needed is a water leak detection device that is sufficiently sized to sense dripping water that falls from any pipes including but not limited to the supply, faucet and drain. The water leak detection device should also include a collection device to collect and hold the water thereby preventing damage to the bottom of the cabinet.

### BRIEF SUMMARY OF THE INVENTION

It is an object of the Sink Alert Water Leak Detector to include a collection tub. The collection tub is configurable in a variety of sizes or shapes to cover the area under the plumbing of a sink or other area that can have a potential water leak. Cabinets for sinks come in a variety of sizes and often the location and distance of the water supply, faucets and drain. The tub basin or holding tank/reservoir can be configured to nearly any volume of fluid by increasing the height of the side walls.

It is an object of the Sink Alert Water Leak Detector for the bottom of the collection tub to be angled. The angle allows even minor amounts of water to run down to a specific area of the collection tub thereby providing the earliest detection time possible. The angle of the slope can be adjustable, but is preferably fixed and based upon the hygroscopic coefficient of friction for the material the tub is fabricated.

It is an object of the Sink Alert Water Leak Detector to have feet that elevate the tub from the bottom of the sink cabinet. The elevated feet allows for air movement under the collecting tub. Should any water exist under the tub then convection evaporation will allow the area to dry without the risk of the wood deteriorating. The feet can take a variety of sized and shapes depending on the size of the collecting tub to reduce the possibility that the tub might sag and thereby allow water to pool in a low area and delay the sounding of a leak alarm.

It is another object of the Sink Alert Water Leak Detector for the inside of the collection tub to have one or more support members such as columns, posts, ribs or the like. These support members provide an elevated surface for the storage of personal items within the cabinet. Any water can then pass under the support members and into the detector circuit. The support(s) ensure that at least some of the entire area that is covered by the leak detector is available to a user.

It is another object of the Sink Alert Water Leak Detector to have an audible alarm. The audible alarm provides one of the fastest methods of notifying a resident that a leak is present. The sensor circuit uses a plurality of contacts that are placed in the lowest location of the collecting tub where water will run down to and thereby bridge the plurality of contacts and trigger the alarm. The combination of the collecting tank with the sensor ensures that all or nearly all drops that can fall or spray from under the sink, water pipes and drain is captured and an alarm can be sounded before any water has accumulated that can cause water damage to the cabinet.

It is still another object of the Sink Alert Water Leak Detector to use other types of alarms such as wired and or wireless transmitters and receivers so a leak in an office, residence or other location can be transmitted and received by a repair person that can travel to the location of the leak without hearing the audible alarm.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows a perspective view of the sink alert water leak detector in a preferred embodiment.

FIG. 2 shows a front view of the sink alert water leak detector.

FIG. 3 shows a side view of the sink alert water leak detector.

FIG. 4 shows a tope view of the sink alert water leak detector.

FIG. 5 shows a perspective view of the sink alert water leak detector in a second preferred embodiment.

FIG. 6 shows a perspective view of the sink alert water leak detector in a third preferred embodiment.

FIG. 7 shows a perspective view of the alarm unit from the sink alert water leak detector.

FIG. 8 shows a block diagram of the electronics in the sink alert water leak detector.

### DETAILED DESCRIPTION OF THE INVENTION

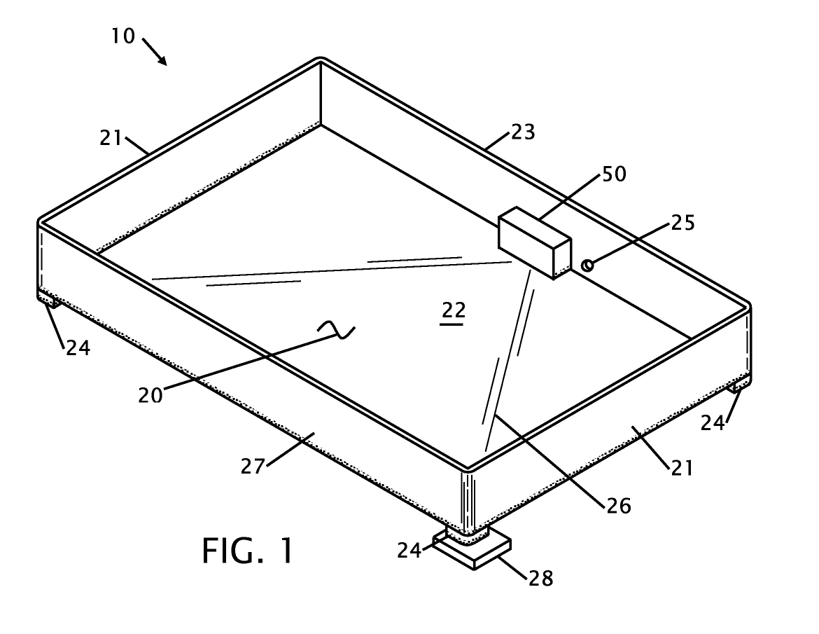

FIG. 1 shows a perspective view of the sink alert water leak detector in a preferred embodiment. In this figure the sink alert water leak detector 10 is shown in a rectangular configuration with a size of about 24 inches wide by 16 inches deep and three inches tall. This size is generally large enough to cover the area under a typical sink, faucet and drainage system. While these dimensions are provided they are used as a particular embodiment but should be understood a generic and any and all of the dimensions are variable to accommodate different size and space requirements to detect a water leak. The housing of the collection tub 20 is preferably made from a plastic material such as but not limited to ABS, PVC, acrylic or others and can be fabricated from assembly, injection molding or other similar method. It is also contemplated that the collection tub 20 can be made from a metal material that is properly treated to prevent rusting or staining the surface the collecting tub 20 is placed upon.

The front wall 27, side walls 21 and back wall 23 elevate from the bottom 22 to both protect from the splash of a drop as well as provide additional water collection volume in the event that the leak continues for an extended period of time before repair can be made. In the embodiment shown a drain hole 25 is shown this drain hole can serve a variety of purposes including the connection of a hose to direct excessive water to an external drain. The drain hole 25 can also be used to drain excessive water from the collection tub 20 to make the tub lighter in weight so it can be more easily removed from under a sink to fully empty any accumulated water.

One or more feet 24 are bonded, formed, assembled or otherwise integrated into the bottom of the sink alert water leak detector. These feet 24 elevate the outer corners of the collection tub 20 to make any water droplets run towards the alarm unit 50. Contour or crease lines 26 are visible where the corners are bent to all water to flow to the alarm unit 50. The height of the feet 24 are fixed or variable and can also be shimmed 28 to level the sink alert water leak detector to accommodate uneven surfaces. The angle allows even minor amounts of water to run down to a specific area of the collection tub 20 thereby providing the earliest detection time possible. The height of the feet 24 can make the angle of the slope, but the height of the feet 24 is preferably fixed and based upon the hygroscopic coefficient of friction for the material the tub 20 is fabricated. The feet 24 also elevate a significant portion of the collection tub 20 to allow for air movement under the collection tub 20 to allow for any moisture under the collection tub 20 to evaporate.

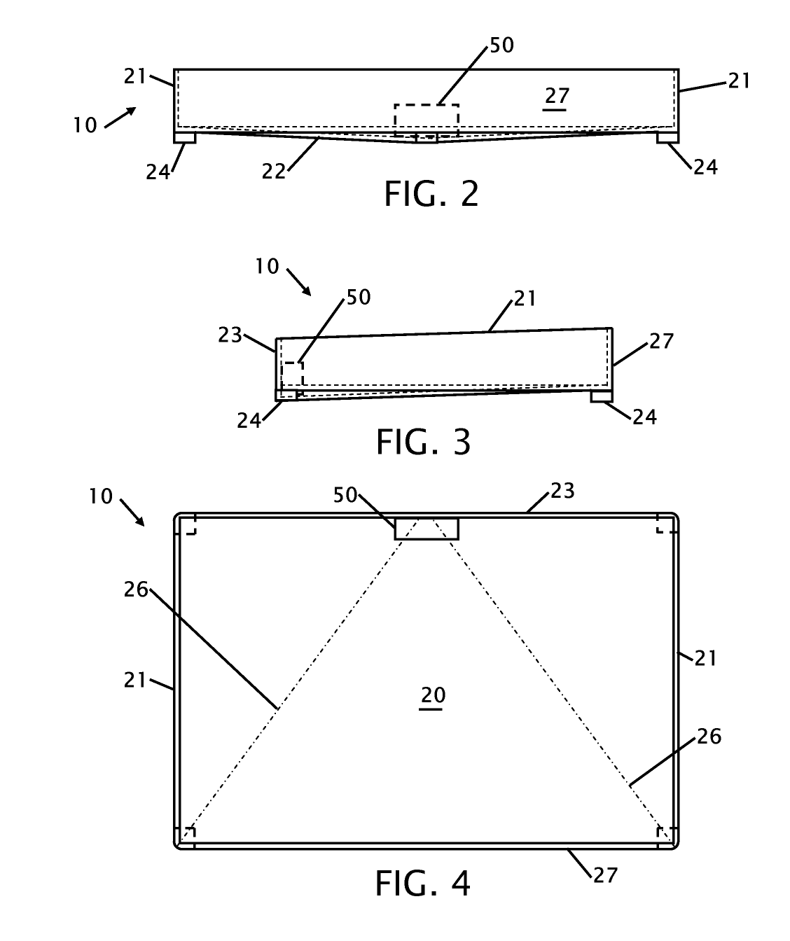

FIG. 2 shows a front view of the sink alert water leak detector, FIG. 3 shows a side view of the sink alert water leak detector and FIG. 4 shows a tope view of the sink alert water leak detector 10. These views represent the preferred embodiment for a collection tub 20 and alarm unit 50 that can be placed within most sink cabinets. The exterior side walls 21 are shown elevated from the bottom surface 20. The side walls in this embodiment are preferably about 3 inches tall and rise from a bottom surface 20 that is approximately 24 by 16 inches. This creates an interior volume that is capable of collection more than four gallons before any water flows over the walls 21, 23 and 27 of the collection tub. The feet 24 are shown elevating the four corners and the alarm unit 50 is shown in a depressed area on the back wall 23 of the collection tub. While in all of the embodiments shown the alarm unit is shown in the middle of the back wall 23 it is contemplated that the alarm unit can be placed along any wall, within any corner or even in the middle of the bottom 22 of the collection tub 20. The contour crease 26 is shown in FIG. 4 and the contour of the crease is shown in the front and side views FIGS. 2 and 3 (not numbered in these figures).

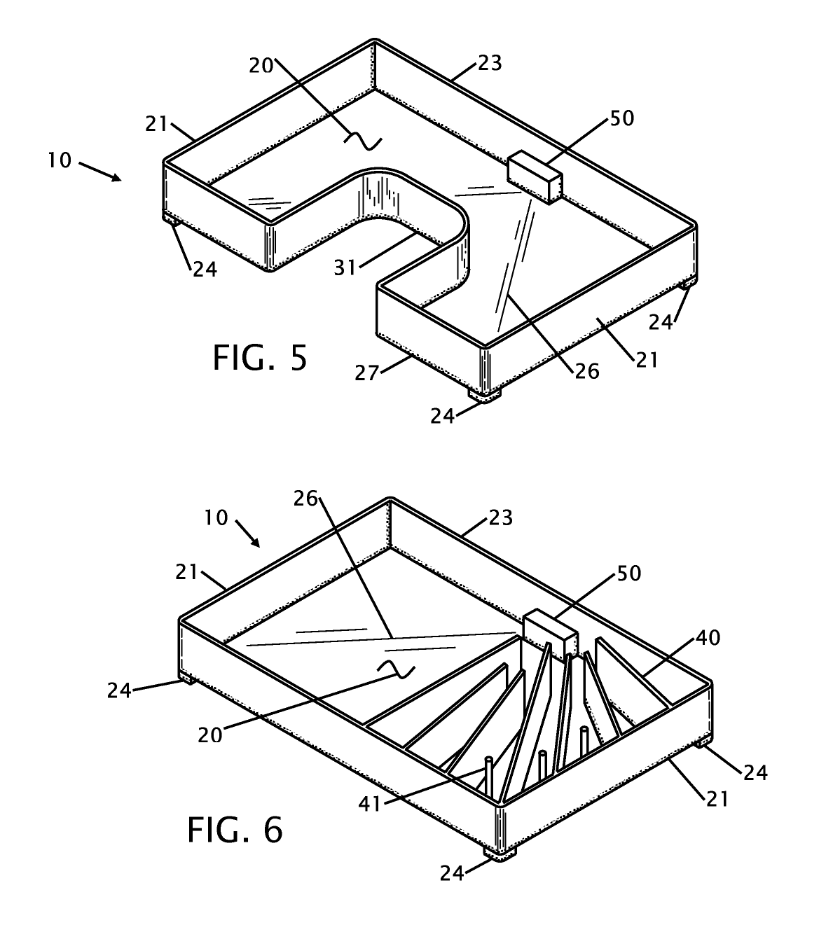

FIG. 5 shows a perspective view of the sink alert water leak detector in a second preferred embodiment and FIG. 6 shows a perspective view of the sink alert water leak detector in a third preferred embodiment. The sink alert water leak detector 10 that is shown in FIG. 5 is configured for placement around the back of a toilet and toilet tank where the loop bowl clearance 31 wraps the front wall 27 around the base of a toilet. This sink alert water leak detector will collect any water that drops from the toilet fill line and the water holding tank of a typical toilet. In both of these figures the sink alert water leak detector 10 has side walls 21, 23 and 27 that rise from the bottom 22 of the collection tub 20. A plurality of feet 24 are shown at the corners of the collection tub 20 to allow water to flow towards the alarm unit 50. Contour creases 26 are shown bending the bottom 22 to allow any drops of water to flow down to the alarm unit 50.

FIG. 6 has a number of internal features that allows a user a surface to place supplies in, or on, the sink alert water leak detector where the supplies are elevated from the bottom of the collection tub 20. The sink alert water leak detector 10 shown in FIG. 10 is a hybrid that allows some supplies to be placed on the bottom (left side) of the collection tub 20 and on the elevated ribs 40 or rods 41. The elevated ribs are configured along the flow lines of the bottom 22 of the collection tub 20. The top of the ribs 40 or rods 41 can be at the same, or lower, height as the surrounding side 21, front 27 and back walls 23.

Dripping water can run down and around any items that are placed on or within the collection tub 20 and then down to the alarm unit 50. Items that can be placed within the left side could be cleaning items that are in non-absorbent (plastic) containers. Items that would be elevated on the right side may be in paper boxes that could potentially absorb water before the water runs to the alarm unit 50.

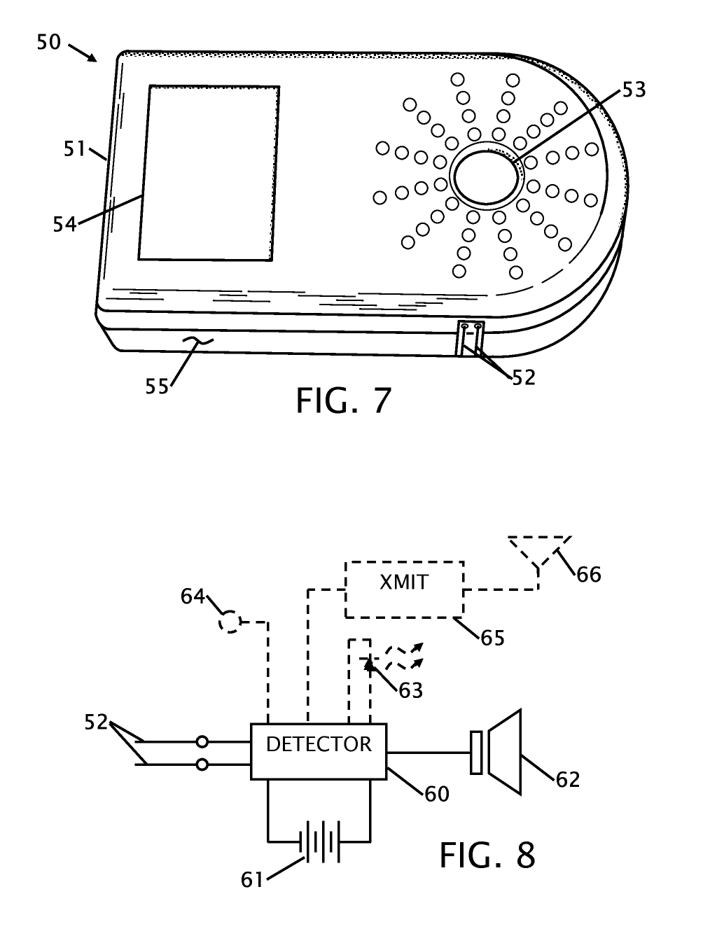

FIG. 7 shows a perspective view of the alarm unit 50 from the sink alert water leak detector. This drawing should be considered a generic view of one contemplated embodiment of the alarm unit 50. The size and shape of the housing 51 is variable with the exception of the conductors 52 that need to exist on an outside surface where they can be placed at the lowest possible location of a collection tub 20 (not shown). The housing 51 is preferably made from a plastic material that is not affected by water. The alarm unit 50 has an alarm sound hole 53 where an audible alarm is emitted. The bottom surface 55 has a plurality of conductors 52 that are connected to an electrical circuit and then to the alarm. In this figure a label area 54 is shown for instructions and or manufacturers identification.

FIG. 8 shows a block diagram of the electronics in the sink alert water leak detector. This figure shows the minimum components that are shown as solid lines and some contemplated optional features that are shown as broken lines. The minimum components that are required for the alarm unit is the conductors 52 that sense moisture and when sufficient moisture has been detected bridging the conductors 52 the detector 60 will sound the alarm speaker or transducer 62. The electronic circuit that is shown is powered by a battery 61 or other similar power source. The detector 60 may further include a voltage detection circuit that sounds an intermittent sound or chirp from the speaker 62 when the battery 61 needs replacement. While it is contemplated that the sink alert water leak detector could be powered by an external AC type power source, the potential for high voltage electrical interaction with water makes external AC type power not as desirable.

Optional connections include but are not limited to a connection 64 for connecting the alarm into an external system such as a whole house alarm system or other external monitoring device. A LED or light 63 that gives a visible indicator that water is present. This is particularly desirable if the homeowner is deaf. An additional optional connection is with a wired or wireless transmitter 65 that is connected to an antenna 66 or other network as may be a pager, cell phone or other network where a service person can be notified to repair a leak when no one is present to hear an alarm.

Thus, specific embodiments of a sink alert water lead detector have been disclosed. It should be apparent, however, to those skilled in the art that many more modifications besides those described are possible without departing from the inventive concepts herein. The inventive subject matter, therefore, is not to be restricted except in the spirit of the appended claims.

1. A Sink Alert Water Leak Detector comprising:
a fluid collection tub;
said fluid collection tub having a bottom surface and a wall that extends essentially vertical from said fluid collection tub:
said fluid collection tub having a contoured surface that allows fluid that is dropped within said fluid collection tub to flow to a particular location within said fluid collection tub, and
an alarm unit having conductors that are located in proximity to said particular location such that when fluid is dropped within said fluid collection tub, said fluid will flow to said particular location causing said alarm unit to emit a signal.

2. The Sink Alert Water Leak Detector according to claim 1 wherein said fluid collection tub is made from plastic.

3. The Sink Alert Water Leak Detector according to claim 2 wherein said fluid collection tub having a contoured surface is contoured based upon a hygroscopic coefficient of friction of said plastic.

4. The Sink Alert Water Leak Detector according to claim 1 wherein said fluid collection tub is configured to be placed within a cabinet under a sink.

5. The Sink Alert Water Leak Detector according to claim 1 wherein said fluid collection tub is configured to be placed under a toilet tank.

6. The Sink Alert Water Leak Detector according to claim 1 wherein said fluid collection tank is configured to be placed under a water heater.

7. The Sink Alert Water Leak Detector according to claim 1 wherein said fluid collection tank has a plurality of feet that elevate at least a portion of the bottom of said fluid collection tank.

8. The Sink Alert Water Leak Detector according to claim 7 wherein said feet are adjustable.

9. The Sink Alert Water Leak Detector according to claim 1 wherein said collection tub is rectangular.

10. The Sink Alert Water Leak Detector according to claim 1 wherein said fluid collection tub has a drain hole.

11. The Sink Alert Water Leak Detector according to claim 1 wherein said signal is audible.

12. The Sink Alert Water Leak Detector according to claim 1 wherein said signal is with an illumination device.

13. The Sink Alert Water Leak Detector according to claim 1 wherein said fluid collection tub has at least one elevated rib or post that is located within said fluid collection tub.

14. The Sink Alert Water Leak Detector according to claim 1 wherein said signal is to an external monitor.

15. The Sink Alert Water Leak Detector according to claim 14 wherein said external monitor is a pager.

16. The Sink Alert Water Leak Detector according to claim 14 wherein said external monitor is a cell phone.

17. The Sink Alert Water Leak Detector according to claim 14 wherein said external monitor is a central alarm.

18. The Sink Alert Water Leak Detector according to claim 1 wherein said alarm is battery powered.

19. The Sink Alert Water Leak Detector according to claim 18 wherein said alarm further includes a low battery voltage detection and notification function.

20. The Sink Alert Water Leak Detector according to claim 1 wherein said alarm is removable from within said fluid collection tub.
